(19) United States
(12) Patent Application Publication
(10) Pub. No.: US 2017/0086471 A1
(43) Pub. Date: Mar. 30, 2017

(54) SINGLE SERVE CAPSULE WITH ACID-TREATED TEA

(71) Applicant: K-FEE SYSTEM GMBH, Bergisch Gladbach (DE)

(72) Inventors: Wolfgang Eppler, Bergisch-Gladbach (DE); Marc Krüger, Bergisch-Gladbach (DE)

(21) Appl. No.: 15/123,128

(22) PCT Filed: Jun. 11, 2015
(86) PCT No.: PCT/EP2015/063022

§ 371 Date: Sep. 1, 2016

(30) Foreign Application Priority Data
Jun. 12, 2014 (DE) 10 2014 108 258.3

(51) Int. Cl. A23F 3/18; B65D 77/20; B65D 85/804

(52) U.S. Cl. CPC A23F 3/18; B65D 85/8043; B65D 77/2024

(57) ABSTRACT

The invention relates to a single serve capsule (1) for producing tea, comprising a capsule body (2) with a capsule base (3) and a filling side (4). A cavity (100) for accommodating a powdered or liquid tea granulate (101) is formed between the capsule base (3) and the filling side (4), a filter element (7) is arranged between the tea granulate and the capsule base, and an acid is added to the cavity.

The present invention relates to a single serve capsule for producing a beverage, said capsule having a capsule body with a capsule base and a filling side, wherein a cavity for receiving tea granules is configured between the capsule base and the filling side, and a filter element is disposed between the tea granules and the capsule base.

Such single serve capsules are generally known in prior art. Single serve capsules of the generic type preparing tea are disclosed in WO 2012/038063, for example.

Single serve capsules of this type in particular for producing a tea beverage are preferably shaped in the manner of a truncated cone or so as to be cylindrical, and are produced from a vacuum-forced plastic film or by plastics injection molding, for example. Said capsules usually have an open filling side with a collar periphery onto which a cover foil is sealed or adhesively bonded, and a capsule base, wherein a particle strainer which is supported on the capsule base is disposed between the tea granules and the capsule base.

In order for a tea beverage to be prepared, the single serve capsule is introduced into a brewing chamber of a preparation apparatus. After or during the closing procedure of the brewing chamber, the capsule, preferably on the closed base side thereof, is opened by means of an opening spike winch is disposed in the brewing chamber, the filling side of the single serve capsule, which is closed by a closing foil, being pierced by means of piercing means after the brewing chamber has been sealed. Pressurized hot water is subsequently conveyed into the single serve capsule. The water perfuses the tea granules, extracting and/or dissolving the substances required for preparing the beverage from the tea granules. The tea granules are Camellia sinensis leaves which may be present in their entirety and/or in a comminuted form, and/or tea-like granules. The single serve capsules according to the prior art have the disadvantage that the tea beverage has an undesirable foam on the surface.

It has therefore been the object of the present invention to provide a single serve capsule in which the disadvantages mentioned in the context of the prior art are avoided.

This object is achieved by a single serve capsule for producing a beverage, said capsule having a capsule body with a capsule base and a filling side, wherein a cavity for receiving tea granules is configured between the capsule base and the filling side, and wherein a filter element is disposed between the tea granules and the capsule base, and an acid is additionally added to the cavity.

As compared with the prior art, the single serve capsule according to the inversion has the advantage that the foam on the surface of the tea beverage is at least significantly reduced and/or very rapidly disintegrates after the tea has been brewed.

The present invention relates to a single serve capsule for producing a tea beverage. The single serve capsules are preferably shaped in the manner of a truncated cone or so as to be cylindrical, and are produced from a vacuum-formed plastic film or by plastics injection molding, for example. Said capsules usually have an open filling side with a collar periphery onto which a cover foil is sealed or adhesively bonded, a capsule base, and a filter element which is preferably supported on the capsule base. The tea granules which are composed in particular of Camellia sinensis leaves which may be present in their entirety and/or in a comminuted form, and/or of tea-like granules, that is to say of vegetable matter which does not originate from the tea shrub tout which is used in the fashion of tea, are provided upstream of the filter element in terms of the flow direction of the beverage to be produced. The filter element ensures that no or only a few particles make their way into the resulting beverage.

In order for a tea beverage to be prepared, the single serve capsule is introduced into a brewing chamber of a preparation apparatus. After or during the closing procedure of the brewing chamber, the capsule, preferably on the closed base side thereof, may be opened by means of an opening spike which is disposed in the brewing chamber, the filling side of the single serve capsule, which is closed by a closing foil, potentially being pierced by means of piercing means after the brewing chamber has been sealed. Pressurized hot water is subsequently conveyed into the single serve capsule. The preparation liquid perfuses the tea granules, extracting and/or dissolving the substances required for preparing the beverage from the tea granules. The tea granules are Camellia sinensis leaves which may be present in their entirety and/or in a comminuted form, and/or tea-like granules, that is to say vegetable matter which does not originate from the tea shrub foot which is used in the fashion of tea.

Prior to the extraction procedure, the single serve portion is preferably sealed in a substantially aroma-tight manner in relation to the environment. However, the single serve capsule need not be hermetically sealed but, prior to the use thereof, may also be provided in a hermetically sealed packaging which is then manually opened, for example, and/or openings which are potentially present in the capsule base and/or in the cover region are covered by a foil which prior to producing the tea is torn off and/or pierced through.

According to the invention, in addition to the tea granules an acid is provided in the cavity. This acid may be present so as to be pulverulent, liquid, and/or bonded to the tea granules. In the case or the acid being pulverulent, said acid is preferably mixed with the tea granules. Alternatively or additionally, the acid may be present together with the filter element, so as to be immobile. The acid may be part of an aroma and/or of a fruit-juice powder, or be of natural origin, for example in the form of lemon peel.

The hot water which flows into the single serve capsule, simultaneously, before and/or after, however in particular beforehand, extracts and/or desorbes the flavoring substances from the tea granules, and/or the acid particles are optionally simultaneously dissolved and mixed with the water, thus reaching the resulting tea beverage.

The acid may be a monovalent or multivalent acid.

The acid is preferably provided so as to be pulverulent.

The acid preferably has a minimum acid dissociation constant value of <6. In the case of a monovalent acid, the acid dissociation constant value of the first stage of protolytic reaction is preferably <6, particularly preferably <5, and most particularly preferably <4. In the case of a multivalent acid, the acid dissociation constant value of the first stage of protolytic reaction is preferably <6, particularly preferably <5, and most particularly preferably <4. Preferably, the acid dissociation constant value of the second stage and particularly preferably of all subsequent stages of protolytic reaction is likewise <6, particularly preferably <5, and most particularly preferably <4.

The acid constant Kₛ is a substance constant providing an indication as to the extent to which a substance reacts in an equilibrium reaction with water in a protolytic reaction. Kₛ is the equilibrium constant of this reaction, multiplied with [Y] (Y being the solvent which is capable of a protolytic reaction) and thus a measure for the strength of an acid. The equilibrium constant here is stated as the negative common logarithm thereof, i.e. as the acid dissociation constant value (pKₛ value).

The acid is preferably a carboxylic acid. The acid is most particularly preferably malic acid (hydroxybutadiene acid), ascorbic acid, citric acid (3-carboxy-3-hydroxy pentanoic diacid), and/or mixtures thereof.

The total proportion of the acid is preferably between 0.6 and 3% by weight in terms of the total mass of tea granules and acid, in particular of pulverulent acid.

The pH value of the resulting tea beverage is preferably <5.8, preferably <5.5, particularly preferably <5.3. However, the pH value should preferably not be less than 3.5, particularly preferably not less than 4.0.

The filter element preferably has a felted structure. This is in particular a needle-felted structure. The filter element is preferably composed of at least one felted structure and one carrier structure, in particular a woven-fabric structure, wherein the felted structure particularly preferably at least comprises a part-portion of the volume of the carrier structure. The felted structure preferably extends across the entire cross section of the carrier structure, but particularly preferably across only a part-region of the height of the carrier structure. The felted structure is preferably connected to the carrier structure in a formfitting, force-fitting, and/or materially integral manner. The filter element preferably has two or more felted structures which are preferably mutually separated by the carrier structure. The thicknesses of the two felted structures may be identical or dissimilar. Preferably, a felted structure which faces the tea granules may be thinner than the felted structure which faces the capsule base, or vice versa. The surface of the felted structure is preferably treated, for example heat treated, so as to fix loose fibers, for example. Preferably, the filter element having a felted structure is merely placed into the capsule, in particular onto the base thereof. However, the filter element may also be connected, in particular in a materially integral manner, to the capsule, in particular to the base thereof. During perforation, the perforation means may penetrate this filter element. Preferably, a plurality of filter elements which have one or a plurality of felted structures and a carrier structure are disposed and optionally mutually connected so as to be on top of one another in the capsule.

According to one preferred embodiment, the pulverulent acid may be immobilized in the felted structure.

The filter element which has the felted structure is produced in that a woven-fabric structure which is composed of longitudinal threads and transverse threads is provided, for example. Single fibers of 0.8-7 dtex are preferably selected for the construction of a felt, in particular of a needled felt. The mutual connection of the individual so as to form a felt, and/or anchoring the latter in the carrier structure preferably cakes places by way of line production process of needling. Herein, needles having reversed barbs pierce the infed fibrous pack at high velocity and are retracted therefrom. By way of the barbs, the fibers are interconnected and/or interlooped with the woven carrier fabric by way of a multiplicity of loops which are created.

The carrier element having one or a plurality of felted structures preferably comprises an area density (also referred to as grammage or as area weight) between 100 and 2000 grams per square meter, particularly preferably between 400 and 1500 grams per square meter, and most particularly preferably of 450-1400 grams per square meter.

The filter element preferably has a thickness between 0.8 and 3.3 millimeters, particularly preferably between 1.1 and 3.0 millimeters, and most particularly preferably 1.2-1.4 millimeters.

The filter element is preferably connected to the capsule base by a materially integral connection, in particular by welding, preferably by ultrasonic welding. The materially integral connection is preferably performed only in a localized manner, in particular along an annulus. The filter element is preferably sealed to the base of the capsule, in particular ultrasonically sealed, and is preferably tensioned. The filter element preferably completely or only partially covers the capsule base.

According to one preferred embodiment, the capsule base has a prefabricated exit opening which is preferably sealed by a foil, wherein the foil particularly preferably has a tear-off tab for manually tearing off the foil. However, the foil may also be pierced open by a perforation means in the brewing chamber. The exit opening preferably has a cross-sectional area of such a size that no appreciable loss of pressure arises when the prepared beverage flows out of the exit opening, even when a perforation means is located in the exit opening. Preferably, the tea beverage downstream of the filter element is substantially non-pressurized, that is to say has an environmental pressure. The exit opening preferably has a diameter between 10 and 14 mm.

The filter element preferably spans the exit opening.

A further subject matter of the present invention is the use of the single serve capsule according to the invention for producing tea.

Exemplary embodiments of the invention are illustrated in the figures and are explained in more derail in the description hereunder. The figures are described in a merely exemplary manner and do not limit the general concept of the invention. The description applies equally to the entire subject matter of the present invention. In the figures:

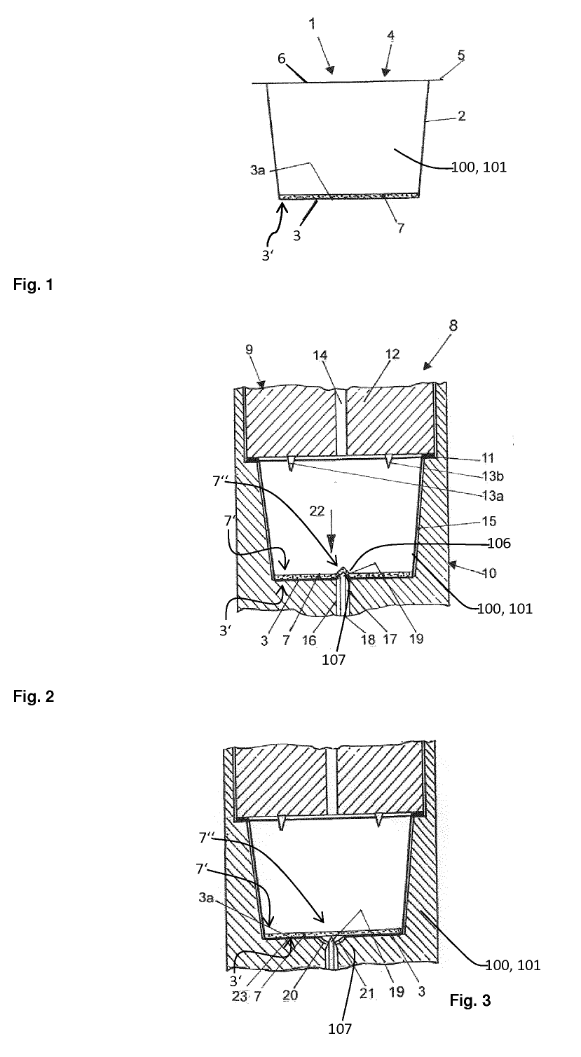

FIG. 1 shows a longitudinal section through a single serve capsule according to a first embodiment of the present invention, which is adapted for preparing tea;

FIG. 2 shows a longitudinal section through a single serve capsule according to the first embodiment of the present invention, lying in a closed brewing chamber;

FIG. 3 shows a longitudinal section through a single serve capsule according to a second embodiment of the present invention, lying in a closed brewing chamber;

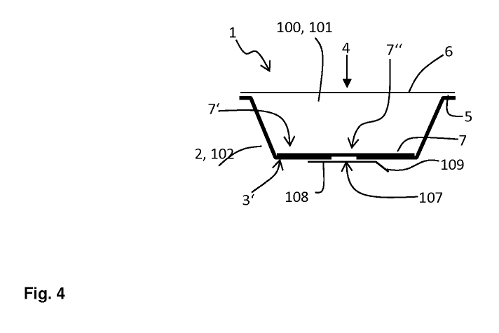

FIG. 4 shows a schematic section view of a single serve capsule having a prefabricated opening, presently in the capsule base region.

In the various figures, the same parts are always provided with the same reference signs, said parts thus typically also feeing referred to or mentioned only once, respectively.

An embodiment of the single serve capsule 1 according to the invention is illustrated in FIG. 1. The single serve capsule 1 comprises a capsule body 2, in the shape of a truncated cone, with a closed capsule base 3 and with a a collar periphery 5 which is disposed on the filling side 4 of said capsule body 2 and onto which a cover foil 6 is welded or adhesively bonded. A cavity 100 which is preferably closed in an airtight and aroma-tight manner, and which is provided with a pulverulent or granulate or leaf-shaped beverage substance 101 is thus configured between the capsule base 3 and the cover foil 6. The beverage substance 101 in the present case comprises Camellia sinensis leaves which are present in their entirety and/or in a comminuted form. Moreover, an acid, preferably in the form of a powder, is provided in the cavity. A filter element 7 having a felted structure is disposed on the internal side 3a of the closed capsule body base 3, that is to say within the cavity 100. The filter element 7 either bears loosely on the internal side 3a of the capsule base 3, or is fixedly connected, that is to say preferably connected in a materially integral manner, to the internal side 3a of the capsule body base 3. In the second variant, the filter element 7 is fixed in a materially integral manner to one capsule base 3 along an annulus particularly only in a peripheral region 3′ of the capsule base 3.

A single serve capsule 1 according to the embodiment of the present invention which is illustrated in FIG. 1 is illustrated in FIG. 2, wherein the single serve capsule 1 in FIG. 2 is disposed in a closed brewing chamber 8. The brewing chamber 8 is composed of a first brewing-chamber element 9 and of a second brewing-chamber element 10, wherein the first brewing-chamber element 9 for inserting the single serve capsule 1 is provided so as to be movable in relation to the second brewing-chamber element 10, or vice versa. A seal 11 is disposed between the two brewing-chamber elements 9, 10. The first brewing-chamber element 3 is composed substantially of a closing piston 12 having piercing elements 13a, 13b for opening the cover foil 6 of the single serve capsule 1, a preparation-liquid in feed 14, and the seal 11. The second brewing-chamber element 10 is composed substantially of a brewing-chamber bell 15 which partially encloses the single serve capsule 1, having an opening spike 16 which is disposed on the base of the brewing-chamber bell 15 and which presently is provided with run-off grooves 17, and of at beverage outlet 18. In order for the single serve capsule 1 to be received, the brewing chamber 8 is in an opened state (not illustrated) in which the first and the second brewing-chamber elements 9, 10 are mutually spaced apart, so as to guarantee infeeding to the single serve capsule 1, and in the closed state (illustrated) in which a preparation procedure for producing a beverage by means of the single serve capsule 1 is capable of being carried out. In the closed state the brewing chamber 8 is tightly closed. While and/or after converting the brewing chamber 8 from the opened state to the closed state illustrated, the cover foil 6 is pierced open by the piercing elements 13a and 13b such that pressurized preparation liquid, in particular hot brewing water, makes its way through the preparation-liquid infeed 14 into the cavity 100 of the single serve capsule 1. Furthermore, while closing the brewing chamber 8, the capsule base 3 is perforated, preferably at a central point 106, by the perforation means which is configured as the opening spike 16 such that an exit opening 107 through which the produced tea may exit from the single serve capsule 1 in the direction of the beverage outlet 18 is created in the single serve capsule 1. In order for discharging of the beverage liquid to be supported, the opening spike 16 on the surface area thereof may have the run-off grooves 17. In the illustration, the base 3 of the single serve capsule 1 which is in the brewing chamber 9, 10 has been pierced open by the opening spike 16 of the second brewing-chamber element, and the filter element 7 which lies above the puncture point has been slightly raised, optionally broached but not pierced through by the piercing tip 12 of the opening spike 16. This is achieved in particular in that the central region 7″ of the felted structure is not connected in a materially integral manner to the capsule base 3, but that the filter element 7 is connected in a materially integral manner to the capsule base 3 only in the peripheral region 3′ of the capsule base 3 such that said filter element 7 as a result of the mechanical contact with the tip of the opening spike 16 is merely raised from the capsule base 3 and thus remains intact (that is to say is broached but not destroyed by the opening spike 16, for example). The capsule base 3 and the filter element 7 remain in mutual contact and in particular so as to be interconnected in a materially integral manner in the peripheral region 3′ of the capsule base 3, or in the peripheral region 7′ of the filter element 7, respectively, such that no beverage substance 101 makes its way around the filter element 7 into the beverage outlet 18.

A single serve capsule 1 according to a second embodiment of the present invention is illustrated in FIG. 3, wherein the second embodiment is substantially identical to the first embodiment which is illustrated in FIG. 2, the single serve capsule 1 being likewise illustrated in a closed brewing chamber 8. However, as opposed to the first embodiment, the single serve capsule base 3 in the piercing region of the opening spike 16 has a bulge 21 which is directed toward a recess 20 in the brewing-chamber base 3a (the bulge 21 is thus directed toward a direction which is counter to that of the filling side 4) and into which the opening spike 16 pierces without piercing through the filter element 7. Raising the filter element 7 from the capsule base 3 is thus not required. In order for the beverage to be produced, the crewing chamber 8 is again closed once the single serve capsule 1 has been introduced into the brewing chamber 8. During the closing procedure the cover foil 6 of the single serve capsule 1 is perforated by means of the piercing means 13a, 13b, brewing water being provided by way of the liquid infeed 14 once the first and the second brewing-chamber elements 9, 10 have been converged and sealed (by means of the seal 11). The opening spike 16 likewise punctures an opening in the base 3 of the single serve capsule 1 during the closing procedure of the brewing chamber. The filter element which lies above the piercing point, in terms of the thickness and tear strength thereof, is adapted to the penetration depth of the piercing tip 19 of the opening spike 16 such that the filter element 7 is preferably not pierced open. Alternatively, the filter element 7 lies above the bulge 21 of the capsule base 3 in the recess of the brewing-bell base 23, and the opening spike 16 merely pierces the bulge 21 of the capsule base 3, not making its way up to the filter element 7. Thereafter, the liquid, which is hot water in the case of tea being brewed, flows into the capsule 1. This liquid in the capsule perfuses the tea granules 101, extracting and/or dissolving the substances required for producing the beverage from the tea granules 101. Moreover, the acid which is present is flushed to the best possible degree from the cavity and thus makes its way into the resulting beverage. The acid here is present in the form of a powder and is dissolved to the best possible degree by the hot water. The flow of the liquid in the cavity 100 through the tea granules 101 is illustrated by the reference sign 22. Thereafter, the resulting beverage flows through the filter element 7 which is disposed between the tea granules 101 and the on the capsule base 3, which prevents particulate component parts of the tea granules 101 making their way into the resulting beverage, and further reaching a collection vessel, for example a cup or a pot, by way of the opening which has been pierced by the opening spike 16 into the capsule base 3 and by way of the run-off grooves 17 of the opening spike 16. The filter element does not retain the dissolved acid.

A sectional view of a single serve capsule 1 according to a further embodiment of the present invention is illustrated in FIG. 4. This embodiment is substantially identical to the embodiment which is illustrated in FIG. 1, wherein the single serve capsules 1 of the present embodiment is equipped with a permanent exit opening 10 in the capsule base 3 which is initially sealed by the foil 108. The foil 108 herein preferably has a tear-off tab 109 for manually tearing off the foil 108. Perforating the capsule base 3 by means of an external perforation means 16 is not envisaged, however is also a conceivable embodiment. Rather, when placing the single serve capsule 1 in the brewing chamber 8, the foil 108 by means of the tear-off tab 109 is simply torn off the capsule base 3, and the brewing procedure may subsequently be started directly without perforating the capsule base 3. However, it is also possible for the foil 108 to remain on the single serve capsule and to be pierced through by the perforation means. The filter element spans the exit opening 108 which is preferably of such a size that no appreciable loss of pressure arises in the outflowing beverage at the exit opening, even when the perforation means is located in the opening. This also applies to the case in which the opening spike is located in the exit opening.

A person skilled in the art will be aware that it is possible that the perforation means 16, when penetrating the capsule, tensions, pierces and/or pierces through the filter element, that is to say that the filter element is at least in portions connected in a materially integral manner to the base of the capsule, is provided and/or tens lowed so as to bear on the base on as large an area as possible, for example.

The following applies to all embodiments described:

The filter element 7 preferably has a carrier structure, for example a woven-fabric structure. A felted structure is disposed on this and/or into this woven-fabric structure on the entire surface which faces the tea, and is connected thereto by needle felting, for example.

One preferred embodiment has two felted structures which each are disposed on and/or in the carrier structure. Both structures preferably extend across the entire cross section, that is to say presently the entire circular surface, of the filter element. The felted structures may have identical or dissimilar thicknesses. Preferably, the one felted structure is embodied so as to be thinner than the other. Then, the carrier layer in relation to the center, and in terms of the thickness, of the filter element is provided so as to be offset. The structures may be produced from dissimilar or identical material(s). This relates not only to the substance from which said structures are produced but also to the thread diameters and/or the thread length from which the felted structures are made. A carrier structure in which no or only a minor amount of felted structure is located and which preferably permits transverse flows is preferably provided between the two structures.

Two filter elements 7 having a felted structure may also be disposed on top of one another. The filter elements may merely bear on one another or be interconnected. However, the filter elements 7 may also have only felt without a carrier structure.

All filter elements having a felted structure have the advantage that they have leas loss of pressure, or that the reduction in pressure takes place at a lesser gradient along the filter element. On account thereof, tea having a reduced foam may be produced, for example. The filter elements having a felted structure arc preferably merely placed into the capsule. The filter element having the felted structure preferably has a larger diameter than the base of the capsule such that the former in the peripheral region presses against the wail of the capsule.

Preferably, the filter element having a felted structure is in particular made entirely from PET.

According to one example of the present invention, 3 grams of Camellia sinensis leaves were weighed to form the granules, and 0.025 grams of pulverulent malic acid was fed. The acid dissociation constant value of the malic acid according to the literature (CD-Roempp, CRC Handbook of Chemistry and Physics, Beyer, Lehrbuch der organischen Chemie) is 3.40 for the first stage of protolytic reaction, and 5.11 for the second stage or protolytic reaction. Both substances were introduced into a single serve capsule of which the capsule base in the center had a clearance having a diameter of 12 mm. A felted structure with an area density of 1150 grams was provided as a filter element on the capsule base. For producing tea, 200 ml of hot water (95° C.) was routed through the single serve capsule, and the resulting tea was collected in a glass tumbler. The pH value of the resulting tea was 5.3. The latter was determined using a pH meter by the Knick company, a Knick 765 pH meter. A few bubbles on the surface of the tea could be established only in the peripheral region of the glass tumbler, said bubbles however vanishing after a short period of time.

### LIST OF REFERENCE SIGNS

1 Single serve capsule
2 Capsule body
3 Capsule base
3a Internal side of capsule base
3′Peripheral region of the capsule base
4 filling side
5 Collar periphery
6 Cover foil
7 Filter element
7′ Peripheral region of the filter element
7″ Central region of the filter element
8 Brewing chamber
9 First brewing-chamber element
10 Second brewing-chamber element
11 Seal
12 Closing piston
13a Piercing element
13b Piercing element
14 Preparation-liquid infeed
15 Brewing bell
16 opening spike
17 Run-out grooves
18 Outlet
13 Piercing tip

20 Recess
21 Bulge

22 Preparation-liquid flow
23 Brewing bell base
100 Cavity
101 Tea granules; acid
102 Side wail region

106 Central point in the capsule base
107 Exit opening
108 Foil
109 Tear-off tab

1. A single serve capsule for producing a beverage, the single serve capsule comprising:
a capsule body;
a capsule base;
a filling side;
wherein a cavity for receiving tea granules is configured between the capsule base and the filling side;
wherein a filter element is disposed between the tea granules and the capsule base,
wherein an acid is added to the cavity; and
wherein the acid has a minimum acid dissociation constant value of <6, and the filter element is a felted structure.

2. The single serve capsule of claim 1, wherein the acid is pulverulent.

3. (canceled)

4. The single serve capsule of claim 1, wherein the acid is a carboxylic acid.

5. The single serve capsule of claim 1, wherein a pH value of the beverage, which is a tea is <5.8.

6. (canceled)

7. The single serve capsule of claim 1, wherein the felted structure comprises an area density between 100 and 2000 grams per square meter.

8. The single serve capsule of claim 1, wherein a thickness of the filter element is between 0.8 and 3.3 millimeters.

9. The single serve capsule of claim 1, wherein the filter element is connected to the capsule base by a materially integral connection, wherein the integral connection is by welding.

10. The single serve capsule of claim 9, wherein the materially integral connection is provided in a localized manner in particular in the form of an annulus.

11. The single serve capsule of claim 1, wherein the filter element is sealed to the base of the capsule.

12. The single serve capsule of claim 1, wherein the filter element completely or only partially covers the capsule base.

13. The single serve capsule of claim 1, wherein the capsule base has an exit opening, which is sealed by a foil,
wherein the foil has a tear-off tab for manually tearing off the foil.

14. The single serve capsule of claim 13, wherein the filter element spans the exit opening.

15. Using the single serve capsule of claim 1 for producing tea.

16. The single serve capsule of claim 1, wherein a pH value of the beverage, which is a tea is 5.5.

17. The single serve capsule of claim 1, wherein a pH value of the beverage, which is a tea is <5.3.

18. The single serve capsule of claim 1, wherein the felted structure comprises an area density between 400 and 1500 grams per-square meter.

19. The single serve capsule of claim 1, wherein the felted structure comprises an area density between 450 and 1400 grams per square meter.

20. The single serve capsule of claim 1, wherein a thickness of the filter element is between 1.1 and 3.0 millimeters

21. The single serve capsule of claim 1, wherein a thickness of the filter element is between 1.2 and 1.4 millimeters.

22. The single serve capsule of claim 11, wherein the filter element is ultrasonically sealed to the base of the capsule, and is tensioned.
